(19) United States
(12) Patent Application Publication
(10) Pub. No.: US 2017/0132683 A1
(43) Pub. Date: May 11, 2017

(54) PRODUCT CUSTOMIZATION SYSTEM AND METHOD

(71) Applicant: Bucket Wonders LLC, Orem, UT (US)

(72) Inventor: Nathan G. Gunderson, Orem, UT (US)

(21) Appl. No.: 15/344,358

(22) Filed: Nov. 4, 2016

Related U.S. Application Data
(60) Provisional application No. 62/252,133, filed on Nov. 6, 2015.

(51) Int. Cl. G06Q 30/06; G06F 17/50

(52) U.S. Cl. CPC G06Q 30/0621; G06Q 30/0641; G06F 17/5009

(57) ABSTRACT

A product customization system is provided to facilitate customization of a consumer product. The product customization system may include an interface, network connected analysis component, database, customization component, simulation component, purchase component, and/or commerce component. A method to operate a system and method to facilitate customization of a consumer product using the product customization system is also provided. The system and method may assist with creating customizable products, for example, souvenirs.

### CROSS-REFERENCE TO RELATED APPLICATION

This application claims the priority from U.S. provisional patent application Ser. No. 62/252,133 filed Nov. 6, 2015. The foregoing application is incorporated in its entirety herein by reference.

### FIELD OF THE INVENTION

The present disclosure relates to product customization systems. More particularly, the disclosure relates to a system and method to facilitate customization of a consumer product.

### BACKGROUND

Many consumers enjoy purchasing customized products. For example, vacationing consumers may desire to purchase customized souvenirs to remember the destinations they visit. However, many consumers are often faced with the unfortunate scenario of not being able to find his or her unique name. This problem is especially troublesome for international consumers, which commonly visit popular tourist destinations that feature customized souvenir products.

The current state of customized products substantially inconveniences many consumers by not having uncommon names or desired variations for customizable fields. Additionally, the current state of customized products potentially deprives businesses of otherwise lucrative sales opportunities because of an inability to match would-be consumers with products displaying their unique names or information. Estimates suggest that the average name-customized product display holds products displaying names for about 50% of the population. In diverse markets, this percentage is typically even lower. Additionally, alternative spellings of names further exasperate this undesirable problem.

Therefore, a need exists to solve the deficiencies present in the prior art. What is needed is a system to facilitate customization of consumer products. What is needed is a system to provide customization options for consumer products. What is needed is an electronically accessible system to order customized souvenir products. What is needed is a method of easily customizing and ordering consumer products, such as souvenir products. What is needed is a system using an access code to associate a merchant and customizable consumer products via an electronic marketplace.

### SUMMARY

An aspect of the disclosure advantageously provides a system to facilitate customization of consumer products. An aspect of the disclosure advantageously provides a system to provide customization options for consumer products. An aspect of the disclosure advantageously provides an electronically accessible system to order customized souvenir products. An aspect of the disclosure advantageously provides a method of easily customizing and ordering consumer products, such as souvenir products. An aspect of the disclosure advantageously provides a system using an access code to associate a merchant and customizable consumer products via an electronic marketplace.

Accordingly, the disclosure may feature a product customization system that includes a database, analysis component, customization component, purchase component, and commerce component. The database may be accessible via a computerized device with a processor and memory. The database may include an access code and merchant information relating to a merchant associated with the access code. The analysis component may associate consumer interaction with the access code and define rules for a marketplace associated with the access code. The customization component may adapt the marketplace to comply with the rules. The marketplace may display a product that is at least partially customizable in compliance with the rules. The purchase component may permit a commercial transaction of the product that has been customized. The commerce component may determine a merchant credit to be provided to the merchant associated with the access code for the commercial transaction.

In another aspect, the system may include an interface via which the marketplace is interactively accessible to view the product associated with the access code and conduct the commercial transaction.

In another aspect, the database may be communicably connected to the analysis component and customization component via a network. The product that is at least partially customizable in compliance with the rules may be displayable over the network via the interface.

In another aspect, the system may include a simulation component to simulate the product that has been at least partially customized in compliance with the rules. The product that has been simulated may be displayable via the interface.

In another aspect, the customization component may receive a customized input from the consumer interaction and may adapt the product that is available to reflect the customized input.

In another aspect, adapting the marketplace by the customization component may include displaying the product that is associated with the access code.

In another aspect, the customization component stylistically may adapt the marketplace in compliance with the rules associated with the access code.

In another aspect, the merchant information may include a listing of products associated with the access code to be made available via the marketplace associated with the access code.

In another aspect, the system may include a fulfillment component to direct production of the product purchased via the purchase component and delivery to a consumer that conducted the commercial transaction.

In another aspect, the fulfillment component may communicate with a fulfillment provider to produce and deliver the product of the commercial transaction.

According to an embodiment of this disclosure, a product customization system is provided that may include a database, analysis component, customization component, and interface. The database may be accessible via a computerized device with a processor and memory. The database may include an access code and merchant information relating to a merchant associated with the access code. The analysis component may be communicably connected to the database via a network to associate consumer interaction with the access code and define rules for a marketplace associated with the access code. The customization component may be communicably connected to the database via the network to adapt the marketplace to comply with the rules. The marketplace may display a product that is at least partially customizable in compliance with the rules. The interface may be provided for the marketplace to be interactively accessible to view the product associated with the access code. The customization component may receive a customized input from the consumer interaction and may adapt the product that is available to reflect the customized input. The product that is at least partially customizable in compliance with the rules may be displayable over the network via the interface. Adapting the marketplace by the customization component may include displaying the product that is associated with the access code.

In another aspect, the system may include a purchase component that may permit a commercial transaction of the product that has been customized. The system may additionally include a commerce component that may determine a merchant credit to be provided to the merchant associated with the access code for the commercial transaction. The commercial transaction may be conducted via the interface.

In another aspect, the system may include a fulfillment component to direct production of the product purchased via the purchase component and deliver to a consumer that conducted the commercial transaction. The fulfillment component may communicate with a fulfillment provider to produce and deliver the product of the commercial transaction.

In another aspect, the system may include a simulation component that may simulate the product that has been at least partially customized in compliance with the rules. The product that has been simulated may be displayable via the interface.

In another aspect, the customization component stylistically may adapt the marketplace in compliance with the rules associated with the access code.

In another aspect, the merchant information may include a listing of products associated with the access code to be made available via the marketplace associated with the access code.

According to an embodiment of this disclosure, a method is provided for customizing a product using a product customization system. The product customization system may include a database accessible via a computerized device with a processor and memory comprising an access code and merchant information relating to a merchant associated with the access code. The method may include (a) associating consumer interaction with the access code and defining rules for a marketplace associated with the access code via an analysis component. The method may also include (b) adapting the marketplace to comply with the rules via a customization component. The marketplace may display a product that is at least partially customizable in compliance with the rules. The method may include (c) permitting a commercial transaction of the product that has been customized via a purchase component. The method may additionally include (d) determining a merchant credit to be provided to the merchant associated with the access code for the commercial transaction via a commerce component. A customized input may be receivable by the customization component from the consumer interaction. The product that is available may be adapted to reflect the customized input.

In another aspect, the method may include (e) providing an interface via which the marketplace is interactively accessible to view the product associated with the access code and conduct the commercial transaction. The database may be communicably connected to the analysis component and customization component via a network. The product that is at least partially customizable in compliance with the rules may be displayable over the network via the interface.

In another aspect, the method may include (f) simulating the product that has been at least partially customized in compliance with the rules via a simulation component. The product that has been simulated may be displayable via the interface.

In another aspect, the method may include (g) adapting the marketplace by the customization component to display the product that may be associated with the access code.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative system and associated components, according to an embodiment of this disclosure.

FIG. 2 is a block diagram view of a computerized device, according to an embodiment of this disclosure.

FIG. 3 is a diagrammatic view of a simulated product customization interface, according to an embodiment of this disclosure.

FIG. 4 is a diagrammatic view of a simulated interface displaying customized products, according to an embodiment of this disclosure.

FIG. 5 is a diagrammatic view of a simulated interface to order customized products, according to an embodiment of this disclosure.

FIG. 6 is a flow chart view of an operation to customize a product, according to an embodiment of this disclosure.

FIG. 7 is a flow chart view of an operation to create a product that has been customized, according to an embodiment of this disclosure.

FIG. 8 is a flow chart view of an operation for customizing and purchasing products using the system, according to an embodiment of this disclosure.

### DETAILED DESCRIPTION

The following disclosure is provided to describe various embodiments of a product customization system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present invention will now be described in detail, without limitation. In the following disclosure, a product customization system will be discussed. Those of skill in the art will appreciate alternative labeling of the product customization system as a name customization system, EveryName system, the invention, or other similar names. Similarly, those of skill in the art will appreciate alternative labeling of the product customization method as a name customization operation, EveryName customization, method, operation, the invention, or other similar names. Skilled readers should not view the inclusion of any alternative labels as limiting in any way.

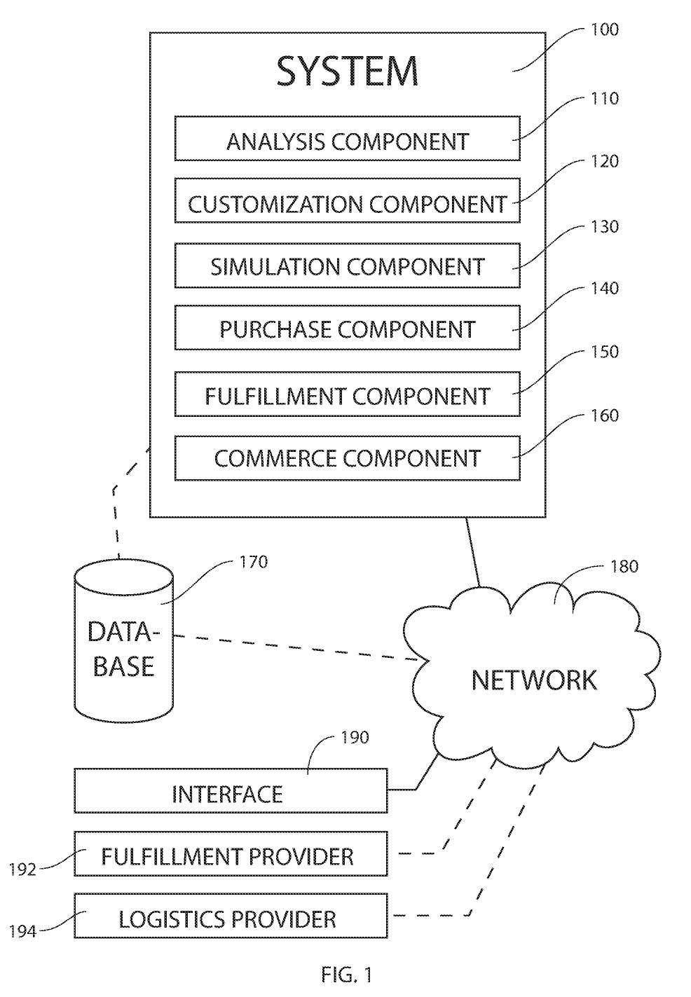

Referring now to FIGS. 1-8, the product customization system will now be discussed in more detail. The product customization system may include a consumer accessible product customization system, interface, analysis component, database, customization component, simulation component, purchase component, commerce component, and additional components that will be discussed in greater detail below. The product customization system may operate one or more of these components interactively with other components to facilitate customization of a consumer product. Illustrative products may include souvenir products, key chains, photo frames, coasters, bracelets, magnets, and/or other products, without limitation.

In one embodiment, one or more of the components of the system may be operated by one physical or logically connected computerized device. The database may additionally be included by a physical or logically connected computerized device. In an alternative embodiment, one or more of the components may be operated on various computerized devices in communication with each other. For example, the database and analysis component may be communicatively connected, such as over a network. In another example, one or more components may be provided by flexible and/or cloud-based computing platforms. Skilled artisans will appreciate additional connection structures by with the components of the system may be operated after having the benefit of this disclosure.

The product customization system will now be discussed in greater detail. The product customization system is highlighted in FIG. 1 and may be further illustrated in other figures.

The product customization system advantageously solves the problem of traditional customized merchandise failing to carry custom details relative to all perspective consumers. For example, an average name display may hold names of about 50% or less of a population. The product customization system of this disclosure advantageously enables consumers to order virtually any name imaginable right from a computerized device, such as their smartphone. Consumers may advantageously customize and order products in a store, after they have left the store, or on virtually any other occasion. Multiple consumers can order custom pieces together. Consumers may also customize products in various languages, which may include character sets unique to a respective language. For example, a consumer with Brazilian, Japanese, or French names may designate precise spelling, characters, and/or accent marks on a customizable product. The system of this disclosure advantageously improves on the shortcomings inherent to current practices.

A purchase made by the system may benefit a merchant like an in-store purchase. The system may track where each sale originates, giving a merchant a credit that is virtually equivalent to an estimated profit from an in-store sale. In one example, a credit may be calculated as the retail price less the wholesale cost. Credit may accumulate for a merchant. Purchases may be associated with a merchant through an access code. Credit may be distributed to a merchant as a payment, credit memo for future invoices, or other payout technique that would be apparent to a person of skill in the art.

Referring to FIG. 1, an illustrative product customization system will now be discussed, without limitation. In this example, the system 100 may be operatively connected to a network 180, which may permit substantially continuous communication with other aspects and providers. The system may include an analysis component 110, customization component 120, simulation component 130, purchase component 140, fulfillment component 150, and/or commerce component 160. These components will be discussed in greater detail below. Skilled artisans will appreciate that while the illustrative product customization system 100 shows the above-mentioned components packaged in a common system, one or more of the components may be held and/or operated remotely from the remaining components without limitation. Additionally, skilled artisans will appreciate that additional components may be included, or listed components may be omitted, in various embodiments of the invention, without limitation.

The system 100 and associated components may connect other aspects of this disclosure via physical or network-based connections. For example, the system 100 may be physically connected to a database 170, which may facilitate the access and storage of information between the components of the system and the database 170. In an alternative example, the system 100 may be operatively connected to the database 170 via a network 180. In a further example, the database 170 and/or one or more of the components may be operated in the cloud via the network 180.

The system 100 may communicate among the components and with aspects via the network 180. For example, the system and its components may communicate with an interface 190 via the network 180. Examples of the interface 190 will be discussed in greater detail below. Additionally, the system 100 may optionally communicably connect with a fulfillment provider 192, logistics provider 194, and/or other providers or vendors. A fulfillment provider 192 may assist with the fulfillment of consumer purchases made via the system. A logistics provider 194 may assist with the organization and/or flow of information generated and communicated by the system.

An access code usable with the consumer accessible product customization system will now be discussed in greater detail. The access code may be included by the database 170. The access code may be associated with a merchant, marketplace, group of marketplaces, and/or other associable entity within the system. The access code may provide an identifier for information included in the database relating to a product customization and/or customized shopping experience.

In one example, an access code may provide an identifier in the database for a merchant and its offerings via a marketplace. The access code may be entered by a consumer upon accessing the system. The access code may be analyzed to direct the consumer to a customized marketplace associated with the access code. The access code may additionally determine the products and/or details relating to the products offered on the customized marketplace. Customizations may include, but should not be limited to, physical product offerings, graphic designs includable with the products, degree of customization for the product, and/or other variables.

The access code may be provided to consumers in a store or merchant location, for example, as a topper to a product display. The access code may be provided with instructions to access the system. In one embodiment, the access code may be included by a QR code, string of characters, or other designation. For example, an access code may be a QR code. Consumers may scan the illustrative QR code with a smartphone or other device to retrieve the access code and/or be directed to the system. When following a smart link, such as provided by a QR code, the system may automatically submit the access code and/or pre-populate a field with the associated access code. In another example, an access code may be manually entered as a string of characters, for example a 4-digit string of characters, on the system for the merchant site. Unique codes may associate a merchant with a consumer order and designs available for the merchant.

Consumers may engage the customization component by entering the access code and providing a customized input for the customizable field. For example, a consumer may simply enter a name he or she desires to appear on the customized device as the customized input. Credit for the commercial transaction associated with the access code may be recorded for the merchant, which may be resolved via a commerce component.

The analysis component 110 will now be discussed in greater detail. The analysis component may detect and receive an access code from a consumer interaction with the system 100. The analysis component 110 may associate consumer interactions with the access code to customize the experience for the consumer. The analysis component 110 may associate merchant information relating to a merchant with the provided access code to customize the marketplace. The merchant information and access code may be provided by the database 170.

In one embodiment, the analysis component may analyze the information associated with the access code to define rules by which the marketplace may operate. For example, the analysis component may determine rules relating to a list of products to display to the consumer. The rules may additionally determine pricing for one or more product in the list of products. The rules may control which products are at least partially customizable, and which aspects of the products may be customized. The rules may additionally affect a virtual styling of the store front.

The customization component 120 will now be discussed in greater detail. The customization component 120 may provide customization of the marketplace and/or product offered through the market place in compliance with rules. The customization component 120 may cooperate with the analysis component 110 to provide a customizable consumer experience.

The customization component 120 may advantageously allow consumers who cannot find their desired product, for example, a product including a customized input, to order it right from their computerized device, for example, a smartphone. In one example, the product may be a souvenir product displaying his or her name, without limitation. The customization component 120 may affect a theme or stylized presentation of a marketplace for the consumer. The marketplace may be accessible by a consumer via an interface usable with the customization component 120. Examples of interface features will be discussed in greater detail below.

In one embodiment, provided without limitation, a consumer may be directed to access the customization component from instructions listed on a personalized product display. In this example, a souvenir product will be discussed. However, those having skill in the art will appreciate the applicability to many other product types in addition to souvenir products after having the benefit of this disclosure. Using the customization component, a consumer may specify virtually any data for a customizable field, for example, a name on a souvenir product. The customization component may allow a consumer to specify a name that is not provided by an in-store display, for example a unique or out-of-stock name.

Consumers may engage the customization component by entering an access code and customized input for the customizable field. For example, a consumer may provide consumer interaction by simply entering a name he or she desires to appear as the customized input via the interface. Shipping and payment info may be added to the order using additional components of the system at checkout.

The simulation component 130 will now be discussed in greater detail. The simulation component 130 may provide a visual simulation of a product customized via the customization component 120. The simulation component 130 may provide a visual representation of a product that is compliant with the rules displaying a customized input provided by a consumer. In some embodiments, the customized input may also require compliance with the rules. The simulated product generated via the simulation component may be displayed for a consumer, for example, via an interface 190.

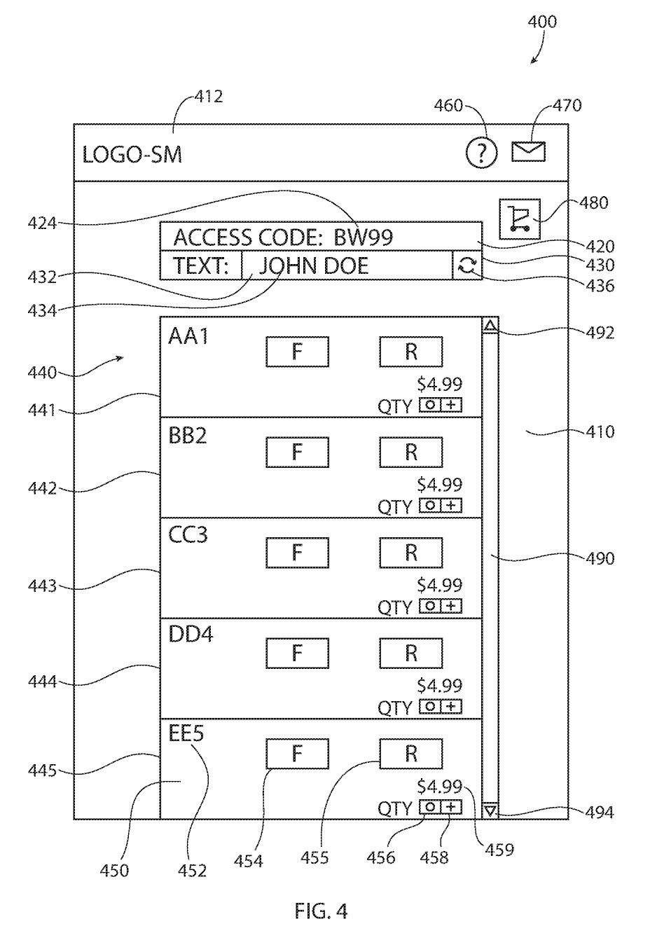

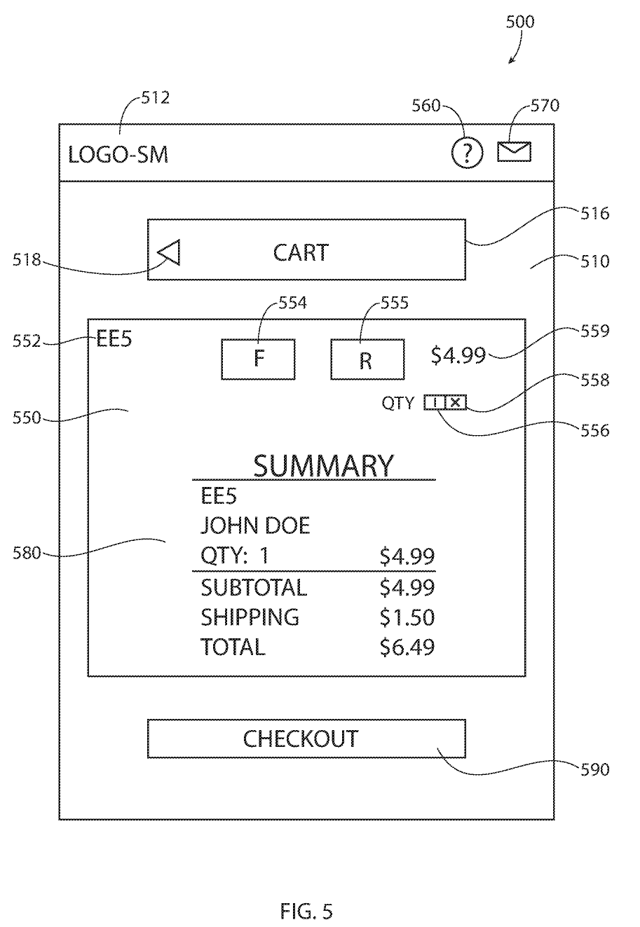

In one example, once a consumer has designated information in the customization field, the simulation component may create virtual proofs of the product for the consumer to review. An example of an interface usable with the simulation component is provided in FIGS. 4-5, which will be discussed in greater detail below. The simulation component may provide the consumer with an image of the product with the desired customization, such as by populating a field with the customized input, so the consumer can see a visual confirmation of what they are ordering.

The purchase component 140 will now be discussed in greater detail. The purchase component 140 may permit performance of a commercial transaction of the product that has been customized, for example, by the consumer. The purchase component 140 may include aspects to facilitate the completion of a commercial transaction, for example, a merchant shopping cart, product display with customized input applied, summary of transaction terms, payment processing, payment confirmation, and/or other aspects associated with a commercial transaction. The purchase component 140 may additionally provide a chance to edit the customization input prior to checkout.

An example of an interface usable with the purchase component 140 is provided in FIG. 5, which will be discussed in greater detail below. After a consumer has customized a design via the customization component 120, and approved a design via the simulation component 130, he or she may enter payment and shipping information to complete the sale via the purchase component 140. The system 100 may be carefully constructed to require as few clicks as possible, maximizing conversion rates. Orders processed via the purchase component may be substantially seamlessly entered in a database. Information provided with the commercial transaction order may be processed by a fulfillment component 150 and directed to an order fulfillment provider 192, which will be discussed in greater detail below.

The fulfillment component 150 will now be discussed in greater detail. The fulfillment component 150 may facilitate the production, manufacturing, and/or assembly of the products purchased in the commercial transaction. The fulfillment component 150 may organize information that may be useful to fulfill the order, directing the information to a fulfillment provider 192. This information may be further organized by a logistics provider 194. In one embodiment, the fulfillment provider 192 may be local for the business or entity operating the system of this disclosure. In another embodiment, the fulfillment provider 192 may be provided off-site, at a third-party facility, or otherwise provided for the business or entity operating the system of this disclosure. Since data for shipping may be entered by the consumer at the time of the commercial transaction, the fulfillment provider 192 may substantially automatically print shipping labels to accompany each order and fulfill the orders with ease.

The system 100, for example, via the fulfillment component 150, may provide instructions to printing machinery and/or finishing machinery to create the customized products using blank inventory and/or raw product. Orders for each merchant may be made to order from the raw products through various printing and finishing techniques, for example and without limitation, dynamic data-driven digital printing. Orders may be printed and fulfilled shortly after being received, in quantities specified for each name and/or customized field of the order. The system may advantageously provide high levels of customization at virtually no extra cost or additional labor.

An illustrative fulfillment component will now be discussed. The fulfillment component may assist with order capturing. The printing and finishing machinery may be directed via the system and its included custom-developed control operations. Once data is collected for the order, it may be output via the system to automatically create content and/or instructions usable by the machinery to produce the products. The system may include modular components, and may allow production of many types of products.

An example of the fulfillment provider interacting with the fulfillment component will now be discussed. Data may be captured from the entry of an order provided by the fulfillment component. A simulated product may be created to assist with fulfillment and/or manufacture on paper, plastic, wood, or another material. After being manufactured and/or the order being fulfilled, the product may be sorted and packaged, and marked as ready to ship. From this example, a highly attractive product that is fully customized can be made with little effort and with requiring virtually nothing but materials to produce.

The commerce component 160 will now be discussed in greater detail. The commerce component 160 may analyze aspects of the commercial transaction to determine a merchant credit to provide to a merchant associated with the access code. For example, the commerce component 160 may retrieve a retail price for products sold through a marketplace associated an access code. The commerce component 160 may additionally access a wholesale price for these products. The commerce component 160 may analyze these values to determine a merchant credit for the commercial transaction. In some embodiments, the merchant credit may be the difference between retail and wholesale prices. In another embodiment, the merchant credit may be otherwise calculated.

The commerce component 160 may assign each merchant a unique code. In some embodiments, the commerce component may associate and/or identify a merchant via the access code associated with the merchant. As discussed above, a consumer can enter the access code via the customization component 120 to initiate a custom order. By using this access code, the system may associate the transaction with a merchant. In one embodiment, the online order may charge the consumer the full retail price for the custom order, plus shipping. In this example, the marketplace associated with the merchant may get credit equaling their retail price minus the wholesale cost. This advantageously provides the merchant with substantially the same profit as if they sold an actual piece from the display. A credit may be accrued as the display continues to sell. In one example of redeeming the credit, when the merchant places a re-order, a credit memo may be issued automatically and the amount will be deducted from the invoice total.

The system may advantageously create products in small runs, for example, via digital printing techniques. The system may additionally facilitate increased customization. Furthermore, the system may advantageously reduce or virtually eliminate the need to carry inventories, increasing profit margins. As demonstrated in this disclosure, this system provides increased flexibility.

The system of this disclosure may advantageously provide efficiency for ordering customized products by including an interface accessible by consumers via a computerized device, such as a smartphone or website. Since the consumer may provide his or her personal information, the system may increase accuracy by minimizing human input error in order processing and production systems. The features may be at least partially automated through the system, which may perform at least the operations illustrated in FIGS. 5-8.

This novel system for offering custom orders advantageously helps merchants respond to demands for custom names and can give merchants a discount on their merchandise. The system and associated method can be integrated with merchants without requiring significant cost or work by the merchant. Perks can be added to the system and integrated by merchants, for example, providing customizable names or information in different languages. These languages may include non-Roman alphabet characters, for example, as used in Japanese, Thai, Cyrillic, Arabic, Chinese, or another language that would be appreciated by skilled artisans. This is an obvious draw for stores in international airport terminals. Additionally, a database of email addresses may be maintained for consumers who have purchased custom orders, to whom products can be easily marketed again.

The product creation machinery will now be discussed in greater detail. Product creation machinery may include printers, cutters, doming machines, and other machinery, which may be at least partially controlled by the system of this disclosure. The production machinery may be operated at a fulfillment facility.

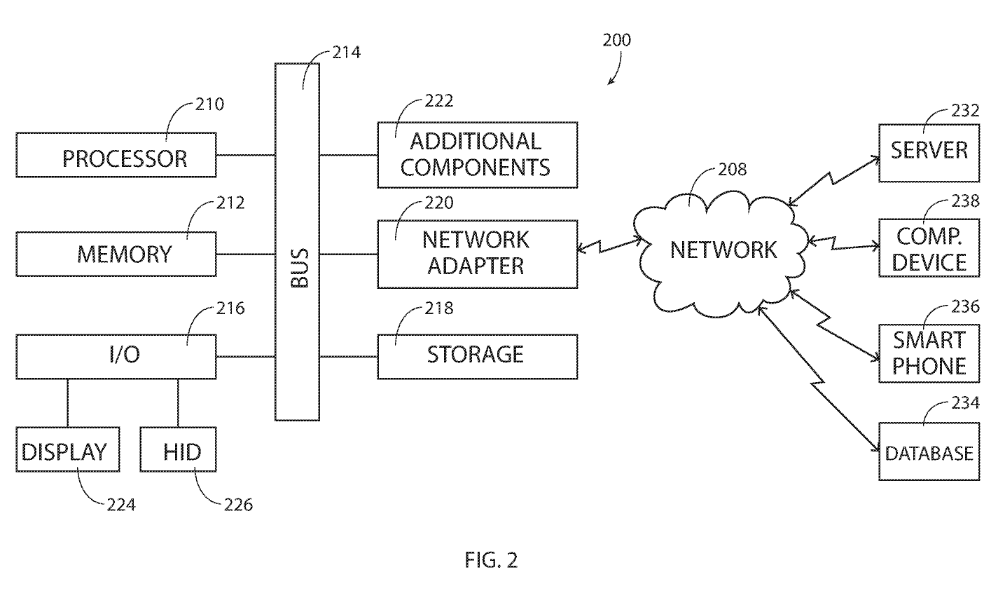

Referring now to FIG. 2, an illustrative computerized device will be discussed, without limitation. Various aspects and functions described in accord with the present disclosure may be implemented as hardware or software on one or more illustrative computerized devices 200 or other computerized devices. There are many examples of illustrative computerized devices 200 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 200 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 200, among others. Additionally, aspects in accord with the present disclosure may be located on a single illustrative computerized device 200 or may be distributed among one or more illustrative computerized devices 200 connected to one or more communication networks.

For example, various aspects and functions may be distributed among one or more illustrative computerized devices 200 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 2 shows a block diagram of an illustrative computerized device 200, in which various aspects and functions in accord with the present disclosure may be practiced. The illustrative computerized device 200 may include one or more illustrative computerized devices 200. The illustrative computerized devices 200 included by the illustrative computerized device may be interconnected by, and may exchange data through, a communication network 208. Data may be communicated via the illustrative computerized device using a wireless and/or wired network connection.

Network 208 may include any communication network through which illustrative computerized devices 200 may exchange data. To exchange data via network 208, systems and/or components of the illustrative computerized device 200 and the network 208 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 200 may transmit data via the network 208 using a variety of security measures including TSL, SSL, or VPN, among other security techniques. The illustrative computerized device 200 may include any number of illustrative computerized devices 200 and/or components, which may be networked using virtually any medium and communication protocol or combination of protocols.

Various aspects and functions in accord with the present disclosure may be implemented as specialized hardware or software executing in one or more illustrative computerized devices 200, including an illustrative computerized device 200 shown in FIG. 2. As depicted, the illustrative computerized device 200 may include a processor 210, memory 212, a bus 214 or other internal communication system, an input/output (I/O) interface 216, a storage system 218, and/or a network communication device 220. Additional components 222 may be selectively connected to the computerized device via the bus 214. Processor 210, which may include one or more microprocessors or other types of controllers, can perform a series of instructions that result in manipulated data. Processor 210 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 210 may be connected to other system elements, including a memory 212, by bus 214.

The illustrative computerized device 200 may also include a network communication device 220. The network communication device 220 may receive data from other components of the computerized device to be communicated with servers 232, databases 234, smart phones 236, and/or other computerized devices 238 via a network 208. The communication of data may optionally be performed wirelessly. More specifically, without limitation, the network communication device 220 may communicate and relay information from one or more components of the illustrative computerized device 200, or other devices and/or components connected to the computerized device 200, to additional connected devices 232, 234, 236, and/or 238. Connected devices are intended to include, without limitation, data servers, additional computerized devices, mobile computing devices, smart phones, tablet computers, and other electronic devices that may communicate digitally with another device. In one example, the illustrative computerized device 200 may be used as a server to analyze and communicate data between connected devices.

The illustrative computerized device 200 may communicate with one or more connected devices via a communications network 208. The computerized device 200 may communicate over the network 208 by using its network communication device 220. More specifically, the network communication device 220 of the computerized device 200 may communicate with the network communication devices or network controllers of the connected devices. The network 208 may be, for example, the internet. As another example, the network 208 may be a WLAN. However, skilled artisans will appreciate additional networks to be included within the scope of this disclosure, such as intranets, local area networks, wide area networks, peer-to-peer networks, and various other network formats. Additionally, the illustrative computerized device 200 and/or connected devices 232, 234, 236, and/or 238 may communicate over the network 208 via a wired, wireless, or other connection, without limitation.

Memory 212 may be used for storing programs and/or data during operation of the illustrative computerized device 200. Thus, memory 212 may be a relatively high performance, volatile, random access memory such as a dynamic random access memory (DRAM) or static memory (SRAM). However, memory 212 may include any device for storing data, such as a disk drive or other non-volatile storage device. Various embodiments in accord with the present disclosure can organize memory 212 into particularized and, in some cases, unique structures to perform the aspects and functions of this disclosure.

Components of illustrative computerized device 200 may be coupled by an interconnection element such as bus 214. Bus 214 may include one or more physical busses (for example, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 214 may enable communications (for example, data and instructions) to be exchanged between system components of the illustrative computerized device 200.

The illustrative computerized device 200 also may include one or more interface devices 216 such as input devices, output devices and combination input/output devices. Interface devices 216 may receive input or provide output. More particularly, output devices may render information for external presentation. Input devices may accept information from external sources. Examples of interface devices include, among others, human interface device (HID) 226 such as keyboard and/or mouse, bar code scanners, mouse devices, trackballs, magnetic strip readers, microphones, touch screens, printing devices, display screens 224, speakers, network interface cards, etc. The interface devices 216 allow the illustrative computerized device 200 to exchange information and communicate with external entities, such as users and other systems.

Storage system 218 may include a computer readable and writeable nonvolatile storage medium in which instructions can be stored that define a program to be executed by the processor. Storage system 218 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk or flash memory, among others. In operation, processor 210 or some other controller may cause data to be read from the nonvolatile recording medium into another memory, such as the memory 212, that allows for faster access to the information by the processor than does the storage medium included in the storage system 218. The memory may be located in storage system 218 or in memory 212. Processor 210 may manipulate the data within memory 212, and then copy the data to the medium associated with the storage system 218 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 200 as shown in FIG. 2. Various aspects and functions in accord with the present disclosure may be practiced on one or more computers having different architectures or components than that shown in FIG. 2. For instance, the illustrative computerized device 200 may include specially-programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 200 may include an operating system that manages at least a portion of the hardware elements included in illustrative computerized device 200. A processor or controller, such as processor 210, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface or perform other functions). Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as a SQL Server available from Microsoft of Redmond, Wash., Oracle Database or MySQL from Oracle of Redwood City, Calif., or integration software such as WebSphere middleware from IBM of Armonk, N.Y.

The interface will now be discussed in greater detail. The interface may be accessible via a computerized device, such as via the illustrative computerized devices discussed above. The interface may permit interaction between a consumer and the system. The interface may additionally permit interaction between other parties, for example, a merchant or system administrator, and the system. The interface may be manipulable via various input techniques, for example, mouse, keyboard, touchscreen, or other input techniques that would be apparent to a person of skill in the art after having the benefit of this disclosure. The interface may include various screens, pages, and other features. In the interest of clarity, a select sample of interface features will be discussed below, without limitation.

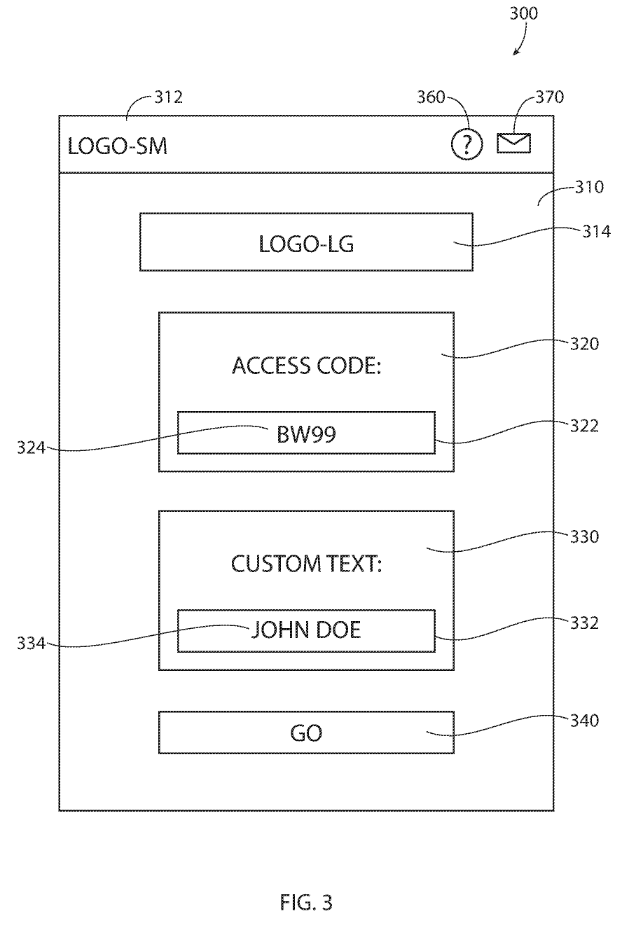

Referring now to the example interface 300 of FIG. 3, an illustrative interface usable with the customization component will now be discussed. This interface may include fields to enter an access code and/or customizable information. The interface usable with the customization component may additionally include links to a Frequently Asked Questions section, contact information, and shortcut to the provider of the system. Once the user has entered his or her customizable information and access code, the user may click “go” to progress to the simulation component.

The interface 300 may include a background 310. The background may provide an aesthetic benefit. Alternatively, the background 310 may provide advertising or other information. The interface 300 may additionally display a logo 312, 314 for the customized marketplace, system platform, and/or other party. The logo may be provided as a persistent corner logo 312, a large banner logo 314, or another form of logo that would be appreciated by a person of skill in the art after having the benefit of this disclosure.

The interface 300 may include an access code module 320. The access code module 320 may include a label, for example, reading “ACCESS CODE” or another indication of the access code module 320. The access code module 320 may additionally include an access code field 322, into which a text string or other information may be entered. The access code field 322 may be populated with data, for example, an access code 324 such as “BW99.” The access code may be analyzed by the analysis component, the result of which may be used to customize the logos and other aspects of the interface.

The interface 300 may include a customization module 330. The customization module 330 may include a label, for example, reading “CUSTOM TEXT” or another indication of the customization module 330. The customization module 330 may additionally include a customization field 332, into which a text string or other information may be entered. The customization field 332 may be populated with data, for example, customized input 334 such as the text “JOHN DOE.” The customization input may be analyzed by the customization component, the result of which may be used to customize aspects of the interface.

The interface 300 may additionally include an advancement button 340. The advancement button 340 may include a label, for example, “GO.” Engagement of the advancement button 340 may navigate the interface to the next page.

The interface 300 may additionally include interactivity features. For example, the interface 300 may include a help button 360 and a contact button 370. The help button 360 may provide access to a frequently asked questions page, a knowledge base, or other help feature. The contact button 370 may provide quick access to draft and submit a message to the merchant, developer, or other definable party.

Referring now to the example interface 400 of FIG. 4, an example of an interface usable with the simulation component will now be discussed. This interface may include a field to change or modify the customizable information, which may be accompanied with a “refresh” button. This interface may additionally include simulated products generated using customizable information supplied via the customization component. The user may select one or more products to order along with a quantity for each selected product. The interface usable with the simulation component additionally may include links to a shopping cart, which may provide the user access to the purchase components. Products displayed in the simulation component may optionally be filtered in accordance with instructions provided by a merchant or store. The interface usable with the customization component may additionally include links to a frequently asked questions section, contact information, and shortcut to the provider of the system.

The interface 400 may include a background 410. The background may provide an aesthetic benefit. Alternatively, the background 410 may provide advertising or other information. The interface 400 may additionally display a logo 412 for the customized marketplace, system platform, or other party. The logo may be provided as a persistent corner logo 412, a large banner logo, and/or another form of logo that would be appreciated by a person of skill in the art after having the benefit of this disclosure.

The interface 400 may include an access code module 420. The access code module 420 may include a label, for example, reading “ACCESS CODE” or another indication of the access code module 420. The access code module 420 may additionally include a text string or other information populated with data, for example, an access code 424 such as “BW99.” The access code may be analyzed by the analysis component, the result of which may be used to customize the logos and other aspects of the interface.

The interface 400 may include a customization module 430. The customization module 430 may include a label, for example, reading “CUSTOM TEXT” or another indication of the customization module 430. The customization module 430 may additionally include a customization field 432, into which a text string or other information may be entered. The customization field 432 may be populated with data, for example, customized input 434 such as the text “JOHN DOE.” The customization component 430 may additionally include a customization field refresh button 436, which may refresh the simulated products with a newly entered customization input 434 upon engagement. The customization input may be analyzed by the customization component, the result of which may be used to customize the product listings and other aspects of the interface. The simulation component may provide simulated views of the products for inclusion in the product listings.

The interface 400 may additionally include a product display module 440. The product display module 440 may include listings for various products provided within compliance with the rules. In the interest of clarity, several illustrative product listings are provided including a first product listing 441, second product listing 442, third product listing 443, fourth product listing 444, and fifth product listing 445. Skilled artisans will appreciate additional products may be listed by the product display module 440.

An illustrative product listing 450 may include various features to clearly convey information about the listed product to the consumer. The information provided in the illustrative product listing 450 may be defined within a database with information associable with an access code. The product listing may include a product identifier 452, such as a stock number or SKU. As an example, the product identifier 452 for the product listing 450 is provided as “EE5.”

The product listing 450 may additionally include a product first view 454 and product second view 455. The first and second views may be front and rear views of a product, respectively. The product listing 450 may additionally indicate a quantity of products to order with a product quantity indicator 456. The quantity of products to order may be manipulated using a product quantity modifier 458. The product listing may additionally display a product price indicator 459, which may be set following rules associated with the access code.

The interface 400 may additionally include interactivity features. For example, the interface 400 may include a help button 460 and a contact button 470. The help button 460 may provide access to a frequently asked questions page, a knowledge base, or other help feature. The contact button 470 may provide quick access to draft and submit a message to the merchant, developer, or other definable party.

The interface 400, for example, the product display module 440 of the interface 400, may include a scroll bar 490 with a scroll up button 492 and a scroll down button 494. The scroll bar 490 may advantageously permit access to product listings that would not otherwise fit in the product display module 440.

Referring now to the example interface 500 of FIG. 5, an example of an interface usable with the purchase component will now be discussed in greater detail. This interface may additionally include a simulated product for the consumer to confirm he or she is ordering the intended product. This interface may additionally include the quantity modifier so that the consumer may adjust the quantity ordered and/or remove products from the cart. The cart summary may be provided to the consumer to confirm that he or she is ordering the desired product. To complete the sale, the consumer may click the checkout button to enter payment and shipping information. Once this information has been entered, the order may be completed and sent to a facility for fulfillment. The interface usable with the customization component may additionally include links to a Frequently Asked Questions section, contact information, and shortcut to the provider of the system.

The interface 500 may include a background 510. The background 510 may provide an aesthetic benefit. Alternatively, the background 510 may provide advertising or other information. The interface 500 may additionally display a logo 512 for the customized marketplace, system platform, or other party. The logo may be provided as a persistent corner logo 512, a large banner logo, and/or another form of logo that would be appreciated by a person of skill in the art after having the benefit of this disclosure. The interface 500 may additionally include a cart page label 516, for example, displaying the title “CART.” A car page back button 518 may additionally be provided to facilitate navigation and making changes prior to finalizing an order. The customization input may be analyzed by the customization component, the result of which may be used to customize the product listings and other aspects of the interface. The simulation component may provide simulated views of the products for inclusion in the product listings.

An illustrative cart listing 550 may include various features to clearly convey information about the proposed purchase to the consumer. The information provided in the illustrative cart listing 550 may be defined within a database with information associable with an access code. The product listing may include a product identifier 552, such as a stock number or SKU. As an example, the product identifier 552 for the cart listing 550 is provided as “EE5.”

The cart listing 550 may additionally include a product first view 554 and product second view 555. The first and second views may be front and rear views of a product, respectively. The cart listing 550 may additionally indicate a quantity of products to order with a product quantity indicator 556. The quantity of products to order may be manipulated using a product quantity modifier 558. The product listing may additionally display a product price indicator 559, which may be set following rules associated with the access code.

The cart listing 550 may additionally include a purchase summary 580, which may include information such as details for the products to be purchased, subtotal, shipping expenses, and order total. The order can be completed by engaging the “CHECKOUT” button 590. The order may be processed via the purchase component.

The interface 500 may additionally include interactivity features. For example, the interface 500 may include a help button 560 and a contact button 570. The help button 560 may provide access to a frequently asked questions page, a knowledge base, or other help feature. The contact button 570 may provide quick access to draft and submit a message to the merchant, developer, or other definable party.

In operation, a method may be provided to facilitate customization of a consumer product. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

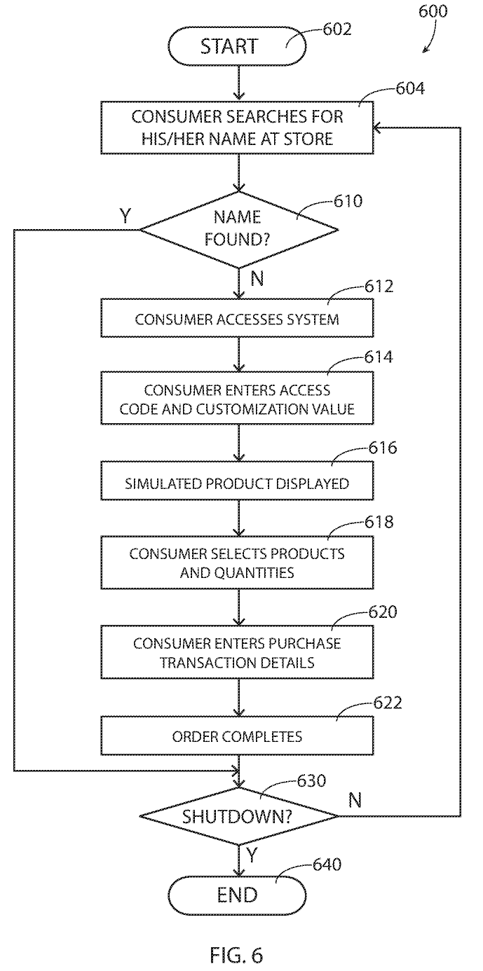

Referring now to flowchart 600 of FIG. 6, an illustrative method for an operation to customize a product will be described, without limitation. The operation of flowchart 600 may include steps for placing an order for a customized product. Starting with block 602, the operation may begin by a consumer searching for a product displaying his or her name, for example, at a store. (Block 604). It may then be determined if the name is found at Block 610. If the name is found at Block 610, the operation may continue to Block 630, as the consumer may purchase the product at the store. If the consumer cannot locate his or her name at Block 610, the consumer may access the product customization system of this example. (Block 612). The consumer may enter an access code and a customization value into the system. (Block 614). The access code may be acquired from a kiosk or display in the merchant store. The system may display one or more simulated products to the consumer. (Block 616). The consumer may select the desired product and quantities for purchase. (Block 618). Once selected, the consumer may enter purchase transaction details. (Block 620). The order may then complete. (Block 622).

It may then be determined whether a command has been received to terminate the system at Block 630. If a terminate command has not been received at Block 630, the operation may return to Block 610 and again await determination as to whether a name was found. If a terminate command was received at Block 630, the operation may end at Block 640.

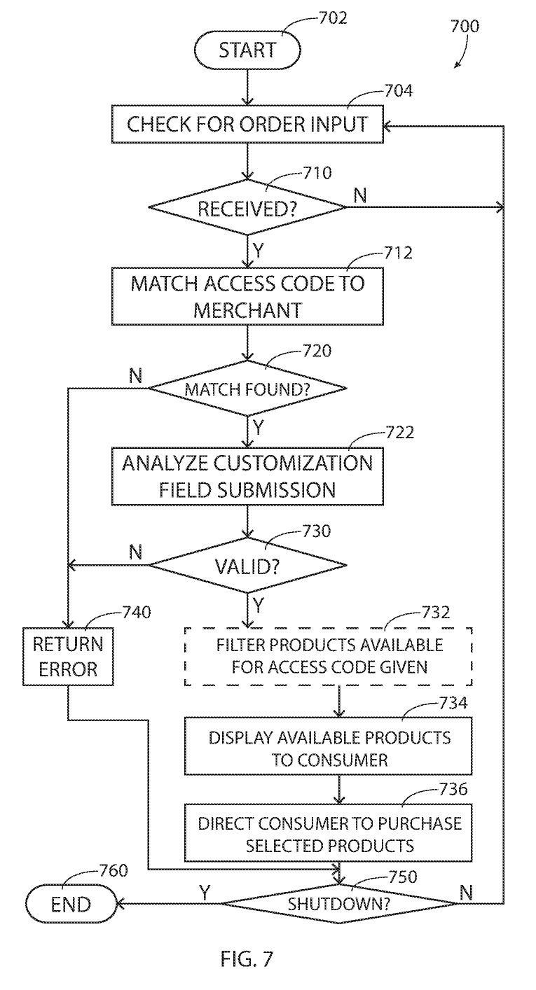

Referring now to flowchart 700 of FIG. 7, an illustrative method for an operation to create a product that has been customized will be described, without limitation. The operation of flowchart 700 may include steps for performing a customization operation. Starting with block 702, the operation may begin by checking for an order input. (Block 704).

The operation may determine if an order input has been received. (Block 710). If it is determined at Block 710 that no order input has been received, the system may loop back and continue to check for inputs at Block 704. If it is determined at Block 710 that an order input has been received, the system may attempt to match an entered access code to a merchant. (Block 712).

The operation may determine if a matching merchant is found for an access code. (Block 720). If it is determined at Block 720 that no match is found, the system may a return an error. (Block 740). After returning the error at Block 740, the operation may continue to Block 750. If it is determined that a match is found at Block 720, the system may analyze the customization field to determine if it is valid. (Block 722).

The operation may determine if the customization field submission is valid. (Block 730). If it is determined at Block 730 that the submission is invalid, the system may a return an error. (Block 740). After returning the error at Block 740, the operation may continue to Block 750. If it is determined at Block 730 that the submission is valid, the system may optionally filter products available for the access code given. (Block 732). The operation may additionally display the available products to the consumer. (Block 734). The consumer may then select the desired products for purchase. (Block 736).

It may then be determined whether a command has been received to terminate the system at Block 750. If a terminate command has not been received at Block 750, the operation may return to Block 704 and again check for an order input. If a terminate command was received at Block 750, the operation may end at Block 760.

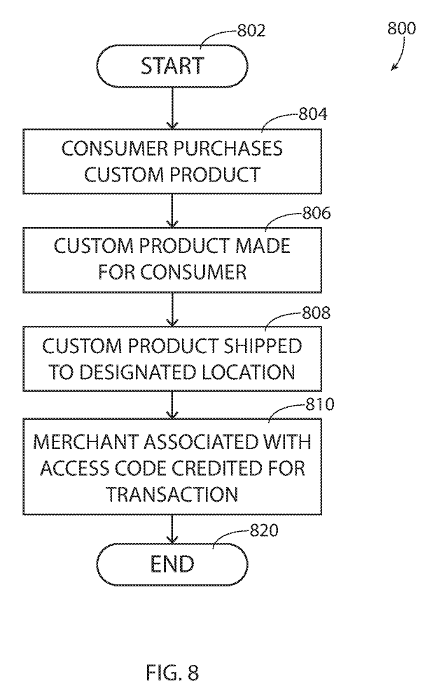

Referring now to flowchart 800 of FIG. 8, an illustrative method for a customizing and purchasing products using the system will be described, without limitation. The operation of flowchart 800 may include steps for product creation and commerce operations such as merchant credit operations. Starting with block 802, after the consumer has customized the product, the consumer may purchase the custom product. (Block 804). The order may be sent to a fulfillment provider. The custom product may be made using the specifications provided by the consumer. (Block 806). For example, the product may be made using printing and/or finishing machinery. The completed product may be packaged and shipped to a location designated by the consumer. (Block 808). Once the order has been fulfilled, the merchant associated with the access code may be credited for the transaction. (Block 810). The operation may end at Block 820.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A product customization system comprising:
a database accessible via a computerized device with a processor and memory comprising:
an access code, and
merchant information relating to a merchant associated with the access code;
an analysis component to associate consumer interaction with the access code and define rules for a marketplace associated with the access code;
a customization component to adapt the marketplace to comply with the rules, the marketplace displaying a product that is at least partially customizable in compliance with the rules;
a purchase component permitting a commercial transaction of the product that has been customized; and
a commerce component to determine a merchant credit to be provided to the merchant associated with the access code for the commercial transaction.

2. The product customization system of claim 1, further comprising:
an interface via which the marketplace is interactively accessible to view the product associated with the access code and conduct the commercial transaction.

3. The product customization system of claim 2, wherein the database is communicably connected to the analysis component and customization component via a network, and wherein the product that is at least partially customizable in compliance with the rules is displayable over the network via the interface.

4. The product customization system of claim 2, further comprising a simulation component to simulate the product that has been at least partially customized in compliance with the rules, the product that has been simulated being displayable via the interface.

5. The product customization system of claim 1, wherein the customization component receives a customized input from the consumer interaction and adapts the product that is available to reflect the customized input.

6. The product customization system of claim 1, wherein adapting the marketplace by the customization component comprises displaying the product that is associated with the access code.

7. The product customization system of claim 1, wherein the customization component stylistically adapts the marketplace in compliance with the rules associated with the access code.

8. The product customization system of claim 1, wherein the merchant information comprises a listing of products associated with the access code to be made available via the marketplace associated with the access code.

9. The product customization system of claim 1, further comprising a fulfillment component to direct production of the product purchased via the purchase component and delivery to a consumer that conducted the commercial transaction.

10. The product customization system of claim 9, wherein the fulfillment component communicates with a fulfillment provider to produce and deliver the product of the commercial transaction.

11. A product customization system comprising:
a database accessible via a computerized device with a processor and memory comprising:
an access code, and
merchant information relating to a merchant associated with the access code;
an analysis component communicably connected to the database via a network to associate consumer interaction with the access code and define rules for a marketplace associated with the access code;
a customization component communicably connected to the database via the network to adapt the marketplace to comply with the rules, the marketplace displaying a product that is at least partially customizable in compliance with the rules;
an interface via which the marketplace is interactively accessible to view the product associated with the access code;
wherein the customization component receives a customized input from the consumer interaction and adapts the product that is available to reflect the customized input;
wherein the product that is at least partially customizable in compliance with the rules is displayable over the network via the interface; and
wherein adapting the marketplace by the customization component comprises displaying the product that is associated with the access code.

12. The product customization system of claim 11, further comprising:
a purchase component permitting a commercial transaction of the product that has been customized;
a commerce component to determine a merchant credit to be provided to the merchant associated with the access code for the commercial transaction; and
wherein the commercial transaction is conducted via the interface.

13. The product customization system of claim 12, further comprising a fulfillment component to direct production of the product purchased via the purchase component and delivery to a consumer that conducted the commercial transaction; and
wherein the fulfillment component communicates with a fulfillment provider to produce and deliver the product of the commercial transaction.

14. The product customization system of claim 11, further comprising a simulation component to simulate the product that has been at least partially customized in compliance with the rules, the product that has been simulated being displayable via the interface.

15. The product customization system of claim 11, wherein the customization component stylistically adapts the marketplace in compliance with the rules associated with the access code.

16. The product customization system of claim 11, wherein the merchant information comprises a listing of products associated with the access code to be made available via the marketplace associated with the access code.

17. A method for customizing a product using a product customization system, the product customization system comprising a database accessible via a computerized device with a processor and memory comprising an access code and merchant information relating to a merchant associated with the access code, the method comprising:
(a) associating consumer interaction with the access code and defining rules for a marketplace associated with the access code via an analysis component;
(b) adapting the marketplace to comply with the rules via a customization component, the marketplace displaying a product that is at least partially customizable in compliance with the rules;
(c) permitting a commercial transaction of the product that has been customized via a purchase component;
(d) determining a merchant credit to be provided to the merchant associated with the access code for the commercial transaction via a commerce component;
wherein a customized input is receivable by the customization component from the consumer interaction; and
wherein the product that is available is adapted to reflect the customized input.

18. The method of claim 17, further comprising:
(e) providing an interface via which the marketplace is interactively accessible to view the product associated with the access code and conduct the commercial transaction;
wherein the database is communicably connected to the analysis component and customization component via a network; and
wherein the product that is at least partially customizable in compliance with the rules is displayable over the network via the interface.

19. The method of claim 18, further comprising:
(f) simulating the product that has been at least partially customized in compliance with the rules via a simulation component, the product that has been simulated being displayable via the interface.

20. The method of claim 17, further comprising:
(g) adapting the marketplace by the customization component to display the product that is associated with the access code.
